(19) United States
(12) Patent Application Publication
(10) Pub. No.: US 2020/0368088 A1
(43) Pub. Date: Nov. 26, 2020

(54) Nose Slit Cloth

(71) Applicants: Maren-Theresa Maier, Kirchheim unter Teck (DE); Woldemar Werner, Kirchheim unter Teck (DE)

(72) Inventors: Maren-Theresa Maier, Kirchheim unter Teck (DE); Woldemar Werner, Kirchheim unter Teck (DE)

(21) Appl. No.: 16/878,641

(22) Filed: May 20, 2020

(30) Foreign Application Priority Data
May 21, 2019 (DE) 102019113544.3

(51) Int. Cl. A61G 13/12; A61G 13/00

(52) U.S. Cl. CPC A61G 13/121; A61G 2200/325; A61G 13/009

(57) ABSTRACT

A face rest cover designed to cover an opening in a treatment table. The face rest cover has a T-shaped slit that has a line-shaped longitudinal slit segment that opens out on an edge of the face rest cover and a transverse slit segment that runs perpendicular to and connects to the longitudinal slit segment. The face rest cover is treated with fragrances. The face rest cover an be used universally, i.e. it can be used as hygienic protection for all kinds of treatment tables. In particular, the treatment table can be used for massages, wellness treatments or also in the fields of physiotherapy and osteopathy.

### CROSS REFERENCE TO RELATED APPLICATIONS

This application claims the priority of DE 102019113544.3 filed on 2019 May 21; this application is incorporated by reference herein in its entirety.

### BACKGROUND

The invention relates to a face rest cover.

Such face rest covers are generally used as liners on treatment tables, while the treatment tables are used for different treatment purposes. Examples of such applications include uses in the fields of physiotherapy or osteopathy. Furthermore, the treatment tables can also be used for massages or general wellness treatments.

Such treatment tables generally have an opening in the head area. A person lying on their stomach on the treatment table can put their face into the opening so they can lie face down on the treatment table without having to raise the head.

For hygienic reasons, the opening of the treatment table is covered with a cover, the dimensions of which are selected such that it rests securely on the edge region bordering the opening of the treatment table.

The cover is designed in the form of a face rest cover that has, for example, a central area cut-out. The mouth and nose region are intended to rest exposed inside the cut-out so the person can breathe without obstruction. Providing such face rest covers with an arrangement of line-shaped slits is also known. In this case, once the person's face is lying on the face rest cover, the edge regions of the face rest cover bordering the line-shaped slits are intended to flip open such that the mouth and nose region of the person are exposed.

Known face rest covers generally have the disadvantage, however, that their slit structure is such that cut-outs are formed through which the person lying down can place their mouth and nose region in order to breathe without obstruction. However, frequently the edge regions bordering slits annoyingly flip down on the mouth and nose region of the person, which is perceived as extremely annoying.

### SUMMARY

The invention relates to a face rest cover (1) designed to cover an opening (3) in a treatment table (2). The face rest cover (1) has a T-shaped slit (4) that has a line-shaped longitudinal slit segment (5), which opens out at an edge of the face rest cover (1), and a transverse slit segment (6) that connects to and runs perpendicular to the longitudinal slit segment (5). The face rest cover (1) is treated with fragrances.

### DETAILED DESCRIPTION

The invention seeks to solve the problem of providing a face rest cover with expanded functionality.

The features of claim 1 are provided to solve this problem. Advantageous embodiments and expedient further developments of the invention are described in the dependent claims.

The invention relates to a face rest cover designed to cover an opening in a treatment table. The face rest cover has a T-shaped slit that has a line-shaped longitudinal slit segment that opens out on an edge of the face rest cover and a transverse slit segment that runs perpendicular to and connects to the longitudinal slit segment. The face rest cover is treated with fragrances.

The face rest cover according to the invention can be used universally, i.e. it can be used as hygienic protection for all kinds of treatment tables. In particular, the treatment table can be used for massages, wellness treatments or also in the fields of physiotherapy and osteopathy.

In general, the face rest cover according to the invention forms a hygienic protection for a treatment table such that an opening in the head region of the treatment table can be covered with the face rest cover. If a person lies down with their face on this region and on the face rest cover, the latter flips open in the region of the longitudinal slit segment of the T-shaped slit, such that the mouth and nose region are exposed and the person can breathe without obstruction. An essential advantage of the face rest cover according to the invention is that the flipping open in the region of the longitudinal slit segment occurs such that the edge segments bordering the longitudinal slit segment lie against the sides of the nose region of the person when they flip open, however do not lie against the mouth and nose in an annoying way. High comfort of use is thereby achieved.

This effect is further supported by the T-shaped slit shape. The longitudinal slit segment opens out into the transverse slit segment that runs perpendicular to it. Since the longitudinal slit segment continues to open out at an edge of the face rest cover, as the edge segments bordering the longitudinal slit segment of the face rest cover, two wing-shaped cover segments are obtained which are equally able to flip open over the entire length of the longitudinal slit segment, which enables these cover segments to lie directly against the sides of the nose of the person lying down.

The face rest cover according to the invention therefore has a high degree of comfort of use.

The functionality of the face rest cover is increased by being treated with fragrances that are inhaled by the person lying on the treatment table, whereby generally their feeling of wellness is enhanced. The fragrances are generally applied to the face rest cover in liquid form. The fragrances are highly volatile such that when the face rest cover is used, these fragrances escape in gaseous form from the face rest cover and can be inhaled by the person.

On the one hand, the fragrances can be aromatic substances that lend the face rest cover a pleasant smell. On the other hand, the face rest cover can be treated with essential substances, especially essential oils, which aside from a pleasant smell also have a health-promoting effect, such as ensuring the person can breathe freely.

Such fragrances can be composed, for example, of aloe vera, eucalyptus, lemon grass and similar.

It is advantageous for the face rest covers to be packed in an air-tight fashion. The packaging is opened shortly before use of the face rest covers, such that the fragrances can disperse. Stable long-term storage of the face rest cover is guaranteed in the air-tight package, whereby in particular the fragrances remain intact inside the face rest cover. In general, single and multi-item packages for the face rest covers are possible.

An essential synergy effect is obtained with the face rest covers according to the invention through the fragrances contained therein and the T-shaped slit. If a person is lying on the face rest cover, it is ensured by the T-shaped slit shape that the cover segments bordering the longitudinal slit segment flip open such that they lie to the side, not in front, of the mouth and nose region of the person. As such, these cover segments do not have an annoying effect for the person; instead the cover segments lie directly against the nose region such that the person can directly inhale the fragrances in the face rest cover, i.e. an excellent degree of effectiveness is achieved insofar as the fragrances do not escape uncontrolled into the environment, but rather are inhaled by the person.

It is advantageous for the face rest cover to be composed of a pulp, in particular an absorbent paper or nonwoven. The face rest cover therefore forms a soft, comfortable liner for the person and, in particular, can absorb even larger quantities of fragrances.

The size and geometry of the face rest cover is adapted to the size of the opening in the treatment table, such that the face rest cover rests on the edge region bordering the opening of the treatment table.

Since the sizes of the openings of the treatment tables are typically standardized or at least similar, the face rest cover can also have a correspondingly standardized size.

It is especially advantageous for the face rest cover to have a square contour, whereby the longitudinal slit segment runs along a plane of symmetry of the face rest cover.

Due to the symmetrical design of the face rest cover, it can be placed centered over the opening of the treatment table.

According to a geometrically advantageous design, the longitudinal slit segment runs along a straight line.

Moreover, the T-shaped slit is designed to have mirror symmetry about the longitudinal axis of the longitudinal slit segment.

In general, within the scope of the invention, the term line-shaped slit means a thin, linear incision into the face rest cover such that the edge segments of the face rest cover lie closely adjacent to one another on both sides of the slit.

For the intended function of the face rest cover, it is essential that the transverse slit segment runs perpendicular to the longitudinal slit segment, i.e. the longitudinal axes of the longitudinal slit segment and transverse slit segment run at least approximately perpendicular to one another. In this way, cover segments are obtained that, when a person lies with their face on the face rest cover, flip open evenly across their length and rest to the side of the nose region.

According to a first variant, the transverse slit segment has a line-shaped design.

In that case, the longitudinal slit segment can open out directly at the transverse slit segment.

Alternatively, the longitudinal slit segment and the transverse slit segment can be connected via an area cut-out in the face rest cover.

The cut-out then extends only over a partial segment of the longitudinal axis of the transverse slit segment.

According to a second variant, the transverse slit segment is implemented in the form of an area cut-out.

In that case, the width of the transverse slit segment is significantly smaller than its extension in the direction of its longitudinal axis.

It is expedient for the width of the transverse slit segment to be essentially constant.

### BRIEF DESCRIPTION OF THE DRAWINGS

The invention is explained in the following with reference to the drawings. They show:

FIG. 1A: First exemplary embodiment of the face rest cover in accordance with the invention.

FIG. 1B: The face rest cover from FIG. 1A in a flipped-open state.

FIG. 2A: Second exemplary embodiment from the face rest cover according to the invention.

FIG. 2B: The face rest cover from FIG. 2A in the flipped-open state.

FIG. 3A: Third exemplary embodiment of the face rest cover according to the invention.

FIG. 3B: The face rest cover from FIG. 3A in the flipped-open state.

FIG. 4: Application example for the face rest cover according to the invention as a liner on a treatment table.

### DETAILED DESCRIPTION OF THE PREFERRED EMBODIMENTS

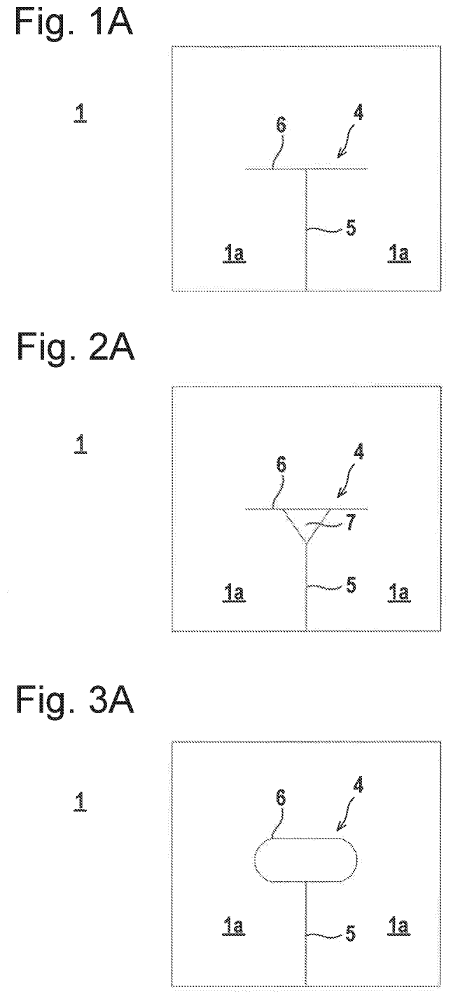

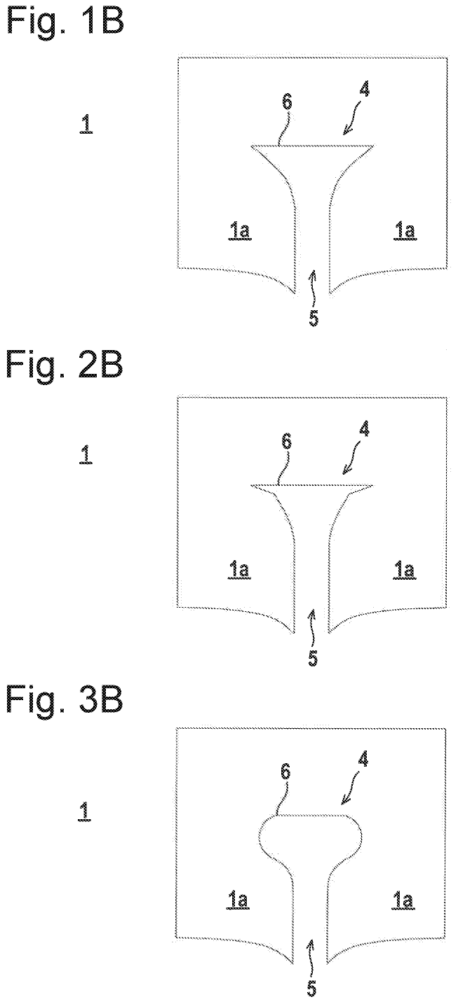

FIGS. 1A, 1B, 2A, 2B and 3A, 3B each show an exemplary embodiment of the face rest cover according to the invention 1.

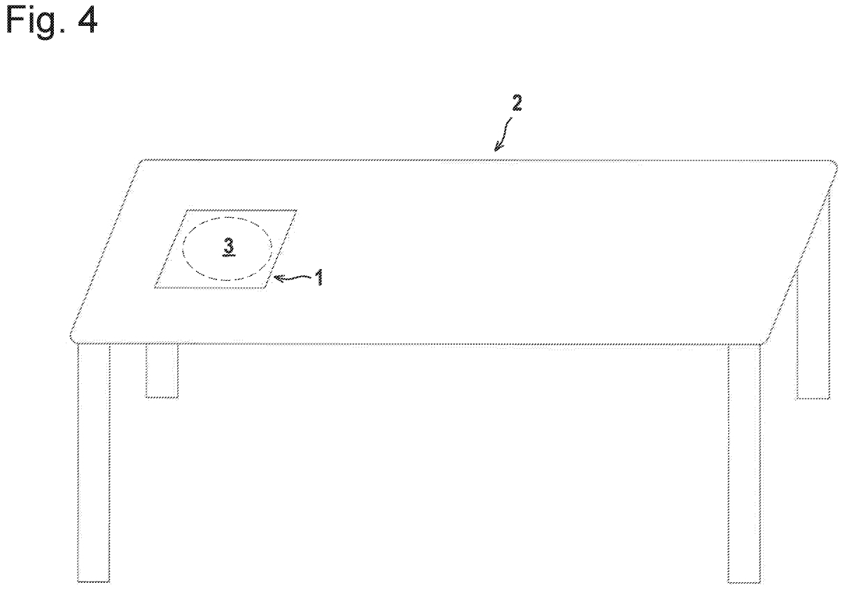

FIG. 4 shows a typical application of this face rest cover 1. The face rest cover 1 is used as hygienic protection for a treatment table 2. When lying on the treatment table 2, a person (not shown) can be treated, whereby the term treatment generally comprises physiotherapeutic, osteopathic and also wellness treatments, such as massages.

The treatment table 2 has an opening 3 in the head region in the known manner. When a person lies on their stomach on the treatment table 2, they can place their face into the opening 3, such that the person lies completely flat on the treatment table 2.

The face rest cover 1 lies on the region of the opening 3 as hygienic protection. The size of the face rest cover 1 is dimensioned such that the face rest cover 1 rests securely on the edge regions surrounding the opening 3.

The face rest cover 1 shown in FIGS. 1A, 1B, 2A, 2B and 3A, 3B is square-shaped, which is not, however, strictly necessary. The face rest cover 1 can be made of pulp, especially from an absorbent paper. Alternatively, the face rest cover 1 can be made of a nonwoven.

According to the invention, the face rest cover 1 is treated with a fragrance. The fragrance is applied to the face rest cover in a fluid state. So that the fragrance remains intact in the face rest cover, the cover is preferably stored in an air-tight package that is opened shortly before use of the face rest cover 1. The fragrances can be implemented as essential substances or aromatic substances.

FIGS. 1A, 1B show a first exemplary embodiment of the face rest cover 1 according to the invention. FIG. 1A shows the face rest cover 1 in its original, unloaded state, i.e. with closed slit structure, while FIG. 1B shows the face rest cover 1 with flipped-open slit structure, such as when a person lies with their face on the face rest cover 1.

As FIG. 1A shows, the face rest cloth has a T-shaped slit 4 that is composed of a longitudinal slit segment 5 and a transverse slit segment 6 that runs perpendicular to it. Running perpendicular means that the longitudinal axis of the transverse slit segment 6 runs at least approximately perpendicular to the longitudinal axis of the longitudinal slit segment 5.

The longitudinal slit segment 5 has a line-shaped design, i.e. adjacent cover segments 1A of the face rest cover 1 directly abut one another along the line-shaped slit.

The longitudinal axis of the longitudinal slit segment 5 runs within a plane of symmetry in the center of the face rest cover 1. One end of the longitudinal slit segment 5 opens out at the lower edge of the face rest cover 1. The other end of the longitudinal slit segment 5 opens out into the transverse slit segment 6. In the present case, the transverse slit segment 6 is line-shaped like the longitudinal slit segment 5. To form the T-shaped slit structure, the longitudinal slit segment 5 opens out in the center of the transverse slit segment 6, such that a T-shape with mirror symmetry is obtained.

FIG. 1B shows the face rest cover 1 from FIG. 1A in the flipped-open state. Due to the T-shaped slit structure, the cover segments 1A bordering the longitudinal slit segment 5 flip open evenly over the length of the longitudinal slit segment 5, by which means it is achieved that these cover segments 1A lie against the side of the mouth and nose region of the person lying on the treatment table 2.

FIGS. 2A, 2B show another exemplary embodiment of the face rest cover 1 according to the invention, whereby FIG. 2A shows the face rest cover 1 with closed slit structure and FIG. 2B shows the face rest cover 1 with flipped-open slit structure.

In accordance with the exemplary embodiment from FIGS. 1A and 1B, the face rest cover 1 from FIGS. 2A and 2B has a T-shaped slit 4 with a line-shaped longitudinal slit segment 5 and a line-shaped transverse slit segment 6.

In contrast to the embodiment from FIGS. 1A and 1B, the longitudinal slit segment 5 of the face rest cover 1 from FIGS. 2A and 2B does not open out directly into the transverse slit segment 6. Rather, an area cut-out 7 is provided between the longitudinal slit segment 5 and transverse slit segment 6, where in the present case this area cut-out 7 is triangular in shape. The cut-out 7 is restricted to the central region of the transverse segment 6, i.e. the longitudinal extension of the cut-out 7 is significantly smaller than the length of the transverse slit segment 6 and also of the longitudinal slit segment 5.

FIGS. 3A, 3B show another exemplary embodiment of the face rest cover 1 according to the invention, whereby FIG. 3A shows the face rest cover 1 with closed slit structure and FIG. 3B shows the face rest cover 1 with flipped-open slit structure.

In accordance with the exemplary embodiment from FIGS. 1A and 1B, the face rest cover 1 from FIGS. 3A and 3B has a T-shaped slit 4 with a line-shaped longitudinal slit segment 5 and a transverse slit segment 6, wherein the longitudinal slit segment 5 opens out directly into the transverse slit segment 6.

In contrast to the embodiment from FIGS. 1A and 1B, the transverse slit segment 6 is implemented in the form of an area cut-out. The width of this cut-out is significantly smaller than the longitudinal extension of the transverse slit segment 6. The width of the transverse slit segment 6 is essentially constant over its length. Only the ends of the transverse slit segment 6 are rounded, such that the width of the transverse slit segment 6 is not constant there.

### LIST OF REFERENCE NUMERALS

(1) Face rest cover
(1a) Cover segment
(2) Treatment table
(3) Opening
(4) T-shaped slit
(5) Longitudinal slit segment
(6) Transverse slit segment
(7) Cut-out

1. A face rest cover (1) designed to cover an opening (3) in a treatment table (2), characterized in that it has a T-shaped slit (4) that has a line-shaped longitudinal slit segment (5), which opens out on an edge of the face rest cover (1) and which has a transverse slit segment (6) that meets the longitudinal slit segment (5) and runs perpendicular to it, and that the face rest cover (1) is treated with fragrances.

2. The face rest cover (1) according to claim 1, characterized in that the longitudinal slit segment (5) runs along a straight line.

3. The face rest cover (1) according to claim 1, characterized in that the T-shaped slit (4) has mirror symmetry about the longitudinal axis of the longitudinal slit segment (5).

4. The face rest cover (1) according to claim 1, characterized in that the transverse slit segment (6) is line-shaped.

5. The face rest cover (1) according to claim 4, characterized in that the longitudinal slit segment (5) opens out directly at the transverse slit segment (6).

6. The face rest cover (1) according to claim 4, characterized in that the longitudinal slit segment (5) and the transverse slit segment (6) are connected via an area cut-out (7) in the face rest cover (1).

7. The face rest cover (1) according to claim 6, characterized in that the cut-out (7) only extends over a partial region of the longitudinal axis of the transverse slit segment (6).

8. The face rest cover (1) according to claim 1, characterized in that the transverse slit segment (6) is in the form of an area cut-out (7).

9. The face rest cover (1) according to claim 8, characterized in that the width of the transverse slit segment (6) is significantly smaller than its extension in the direction of its longitudinal axis.

10. The face rest cover (1) according to claim 8, characterized in that the width of the transverse slit segment (6) is essentially constant.

11. The face rest cover (1) according to claim 1, characterized in that it has a square contour, wherein the longitudinal slit segment (5) runs along a plane of symmetry of the face rest cover (1).

12. The face rest cover (1) according to claim 1, characterized in that it is composed of pulp.

13. The face rest cover (1) according to claim 12, characterized in that it is composed of absorbent paper.

14. The face rest cover (1) according to claim 1, characterized in that it is composed of a nonwoven.

15. The face rest cover (1) according to claim 1, characterized in that the fragrances are essential substances.

16. The face rest cover (1) according to claim 1, characterized in that the fragrances are aromatic substances.
